(19) United States
(12) Patent Application Publication
(10) Pub. No.: US 2025/0002070 A1
(43) Pub. Date: Jan. 2, 2025

(54) RING ASSEMBLY FOR AUTOMATIC AND/OR ASSISTED STEERING AND ASSOCIATED SYSTEMS AND METHODS

(71) Applicant: Ag Leader Technologies, Ames, IA (US)

(72) Inventor: Jonathan Brand, Ames, IA (US)

(21) Appl. No.: 18/761,041

(22) Filed: Jul. 1, 2024

Related U.S. Application Data
(60) Provisional application No. 63/524,065, filed on Jun. 29, 2023.

(51) Int. Cl. B62D 1/10; B62D 1/06; B62D 1/16

(52) U.S. Cl. CPC B62D 1/10; B62D 1/06; B62D 1/16

(57) ABSTRACT

Described therein is an improved assisted steering system includes a built-in/integrated ring on the steering wheel, for use with a mobile/removable drive unit. In various implementations, the built-in/integrated ring is non-removeable, such that issues with misalignment do not occur from installation error or during use. Further, because the drive unit is mobile/removable, the drive unit may be moved between vehicles without removing the steering wheel. In various implementations, the assisted steering system may be used by multiple vehicles simply by installing the steering wheel with integrated ring in each vehicle desired to have assisted steering and installing the drive unit in the vehicle desired to be driven at that time. Further because the steering wheel is not removed when moving the drive unit, the vehicle remains operational and drivable by manual steering.

### CROSS-REFERENCE TO RELATED APPLICATION(S)

This application claims the benefit under 35 U.S.C. § 119 (e) to U.S. Provisional Application 63/524,065, filed Jun. 29, 2023, and entitled RING ASSEMBLY, which is hereby incorporated herein by reference in its entirety for all purposes.

### TECHNICAL FIELD

The disclosure relates to devices for use in automatic and/or assisted steering including a ring assembly for attaching a removable drive unit to a steering wheel/column for a vehicle.

### BACKGROUND

Current assisted steer products on the market have shortcomings that reduce performance and customer experience. One type of assisted steering system on the market includes a two-piece component that attaches underneath a steering wheel and a removable drive unit. In these prior known systems, the removable drive unit and two-piece components are separate components and able to move from vehicle to vehicle. If the two-piece component attached to the steering wheel is not perfectly aligned when assembled, the system may create excess noise and reduce performance when in use.

A second type of assisted steering system includes a drive unit incorporated into the steering wheel. These systems may not suffer from the misalignment related issues of the system with a removable drive unit, however, to move the system from one vehicle to another, the entire steering wheel must be moved. Because the entire steering wheel must be removed a vehicle where the system is not installed would be disabled unless a different steering wheel is reinstalled (such as the factory steering wheel). As would be appreciated disabling a vehicle and/or installing and reinstalling multiple steering wheels is time consuming and can lead to a loss of productivity.

### BRIEF SUMMARY

Described herein are various assisted steering systems and related to devices, systems and methods including a unified ring assembly for use with a removable drive unit. Although multiple implementations, including various devices, systems, and methods of the assisted steering system and ring assembly are described herein as a system, this is in no way intended to be restrictive.

In Example 1, an assisted steering assembly comprising a steering wheel and a ring assembly permanently integrated with the steering wheel, the ring assembly comprising an inner ring, a ring gear disposed on one side of the inner ring, and a gear cover disposed at least partially about the ring gear.

Example 2 relates to the assisted steering assembly of any of Examples 1 and 3-9, wherein the ring gear is affixed to the inner ring via one or more fasteners.

Example 3 relates to the assisted steering assembly of any of Examples 1-2 and 4-9, further comprising a drive unit configured for releasable attachment to the ring assembly.

Example 4 relates to the assisted steering assembly of any of Examples 1-3 and 5-9, wherein the steering wheel further comprises an outer ring configured for operator grip.

Example 5 relates to the assisted steering assembly of any of Examples 1˜4 and -6-9, further comprising an insert installed in a central hub of the steering wheel, the insert configured to interface with a steering column of a vehicle.

Example 6 relates to the assisted steering assembly of any of Examples 1-5 and 7-9, wherein the insert comprises one or more of a notch, a plurality of splines, and one or more shaped protrusions.

Example 7 relates to the assisted steering assembly of any of Examples 1-6 and 8-9, wherein the inner ring and ring gear are integral.

Example 8 relates to the assisted steering assembly of any of Examples 1-7 and 9, further comprising an anti-rotation pin extending from the ring assembly and an anti-rotation bracket disposed on a steering column configured to prevent rotation of the steering wheel during use of an assisted steering system.

Example 9 relates to the assisted steering assembly of any of Examples 1-8, wherein the ring assembly is formed with the steering wheel.

In Example 10, an assisted steering system comprising a first steering wheel having a first integral ring assembly configured for installation in a first vehicle, a second steering wheel having a second integral ring assembly configured for installation in a second vehicle, and a drive unit configured for releasable attachment to the first integral ring assembly and the second integral ring assembly.

Example 11 relates to the assisted steering system of any of Examples 10 and 12-18, wherein each of the first integral ring assembly and the second integral ring assembly comprise an inner ring and a ring gear disposed on one side of the inner ring.

Example 12 relates to the assisted steering system of any of Examples 10-11 and 13-18, wherein each of the first integral ring assembly and the second integral ring assembly comprise a gear cover disposed at least partially about the ring gear.

Example 13 relates to the assisted steering system of any of Examples 10-12 and 14-18, wherein the inner ring and ring gear are integral.

Example 14 relates to the assisted steering system of any of Examples 10-13 and 15-18, wherein the first steering wheel further comprises an insert installed within a central hub of the first steering wheel configured to interface with a steering column of the first vehicle.

Example 15 relates to the assisted steering system of any of Examples 10-14 and 16-18, wherein the insert comprises one or more of a notch, a plurality of splines, and one or more shaped protrusions.

Example 16 relates to the assisted steering system of any of Examples 10-15 and 17-18, wherein each of the first steering wheel and second steering wheel further comprise an anti-rotation pin extending from the respective ring assembly and an anti-rotation bracket disposed on a steering column configured to prevent rotation of the respective steering wheel during use.

Example 17 relates to the assisted steering system of any of Examples 10-16 and 18, wherein the first vehicle remains operational when the drive unit is attached to the second integral ring assembly.

Example 18 relates to the assisted steering system of any of Examples 10-17, wherein the first integral ring assembly is formed with the first steering wheel and wherein the second integral ring assembly is formed with the second steering wheel.

In Example 19, an assisted steering assembly comprising a steering wheel, a ring assembly permanently integrated with the steering wheel, the ring assembly comprising an inner ring, a ring gear disposed on one side of the inner ring, and a gear cover disposed at least partially about the ring gear, an anti-rotation pin extending from the ring assembly, an anti-rotation bracket disposed on a steering column configured to prevent rotation of the steering wheel, and a drive unit configured for releasable attachment to the ring assembly.

Example 20 relates to the assisted steering assembly of Example 19, further comprising an insert installed in a central hub of the steering wheel, the insert configured to interface with the steering column.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 shows a steering wheel, according to one implementation.

FIG. 2, shows a bottom view of the steering wheel of FIG. 1, according to one implementation.

FIG. 3 depicts a steering wheel with the ring gear and insert installed, according to one implementation.

FIG. 4 is an exploded view of the steering wheel, spline insert and ring gear, according to one implementation.

FIG. 5A shows a steering wheel keyed shaft insert, according to one implementation.

FIG. 5B shows a steering wheel spline insert, according to one implementation.

FIG. 5C shows a steering wheel spline insert, according to one implementation.

FIG. 6 depicts an assembled ring assembly, according to one implementation.

FIG. 7 depicts a steering wheel, ring assembly, anti-rotation pin and anti-rotation bracket installed on sample steering column, according to one implementation.

FIG. 8 depicts the full system having the drive unit installed, according to one implementation.

### DETAILED DESCRIPTION

Described therein is an improved assisted steering system includes a built-in/integrated ring on the steering wheel, for use with a mobile/removable drive unit. In various implementations, the built-in/integrated ring is non-removeable, such that issues with misalignment do not occur from installation error or during use. Further, because the drive unit is mobile/removable, the drive unit may be moved between vehicles without removing the steering wheel. In various implementations, the assisted steering system may be used by multiple vehicles simply by installing the steering wheel with integrated ring in each vehicle desired to have assisted steering and installing the drive unit in the vehicle desired to be driven at that time. Further because the steering wheel is not removed when moving the drive unit, the vehicle remains operational and drivable by manual steering.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. Patent Application 16,523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,334, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. Patent Application 63/525,525, filed Jul. 7, 2023, entitled “Assisted Steering Systems and Associated Devices and Methods for Agricultural Vehicles,” U.S. Patent Application 63/593,837, filed Oct. 27, 2023, entitled “Agricultural Implement Position Sensor and Related Devices, Systems, and Methods,” U.S. Patent Application 63/603,969, filed Nov. 29, 2023, entitled “Devices, Systems and Methods for Guidance Line Shifting,” U.S. Patent Application 63/607,227, filed Dec. 7, 2023, entitled “Header Height Control Devices, Systems and Methods,” U.S. Patent Application 63/609,758, filed Dec. 13, 2023, entitled “Magnetic Stripper/Deck Plate Sensing System,” U.S. Patent Application 63/626,744, filed Jan. 30, 2024, entitled “Grain Cart Unloading Sensor and Unload Control,” U.S. Patent Application 63/646,038, filed May 13, 2024, entitled “Seed Tube Camera and Related Devices, Systems, and Methods,” U.S. Patent Application 63/646,068, filed May 13, 2024, entitled “Seed Tube Camera and Related Devices, Systems, and Methods,” U.S. Patent Application 63/651,831, filed May 24, 224, entitled “Non-Contact Methods for Interactions in Navigational Space of Relatively Located Mobile Systems, and Related Devices and Systems,” U.S. Patent Application 63/654,634, filed May 31, 2024, entitled “Equipment Thermal Monitoring System and Associated Methods and Devices,” each of which is incorporated herein by reference.

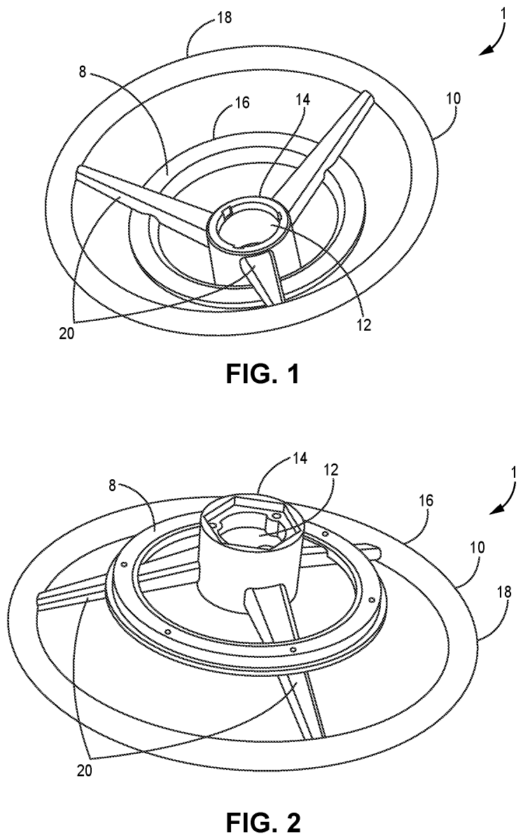

Turning now to the figures in more detail, FIGS. 1-2 depict an assisted steering assembly 1 including a ring assembly 8 integrated with/permanently located on a steering wheel 10, according to certain implementations. The assisted steering assembly 1 and steering wheel 10 include a central opening 12 defined fully or partially through the central hub 14. In these and other implementations, the steering wheel 10 has an inner ring 16 (as part of the ring assembly 8) and outer ring 18, though alternate configurations are of course possible. As would be generally understood, the outer ring 18 is the portion of the steering wheel where an operators hands grip the steering wheel to steer the vehicle.

Further, one or more spokes 20 are disposed radially about the central hub 14 so as to support and rotationally fix the rings 16, 18 to the hub 14, as would be readily appreciated. Various alternative shapes and configurations are of course possible and would be appreciated by those of skill in the art. For example, the outer ring 18 may be an incomplete circle or other shape entirely.

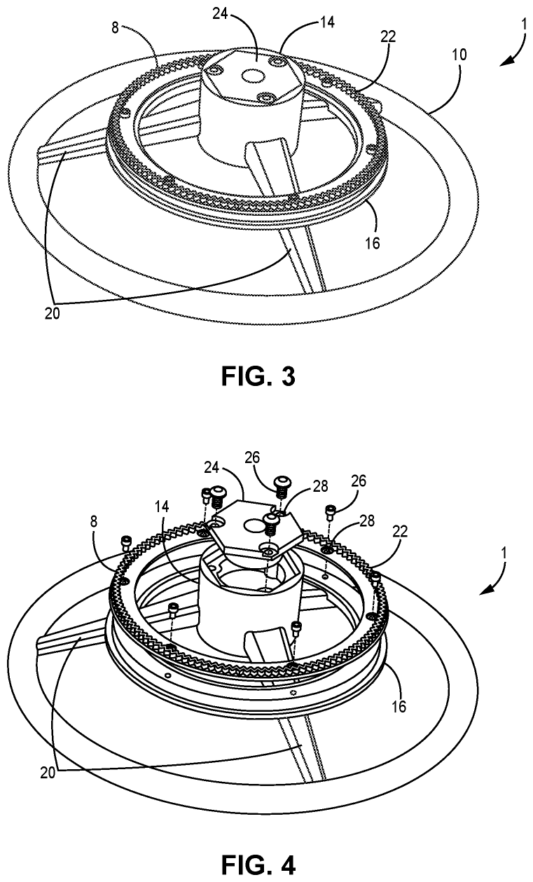

FIG. 3 depicts a steering wheel 10 with the ring gear 22 and spline/keyed insert 24 installed or otherwise affixed thereto at the inner ring 16 and central hub 14, respectively, as would be appreciated. As can be seen, as part of the ring assembly 8, the ring gear 22 is affixed to the underside of the inner ring 16 via a plurality of fasteners, such as screws. Various different fastener types are possible including adhesive. In alternative implementations, the ring gear 22 may formed with or integral to the inner ring 16 such that fasteners are not required, as would be understood.

In various implementations, the spline/keyed insert 24 is positioned within the central opening 12 of the central hub 14. The spline/keyed insert 24 is optionally affixed in place via one or more fasteners, such as screws although various alternative fastener types are possible and would be understood.

FIG. 4 is an exploded view of the steering wheel 10, ring assembly 8 including the ring gear 22, and spline/keyed insert 24, along with accompanying fasteners 26 disposed through corresponding openings 28, according to certain implementations.

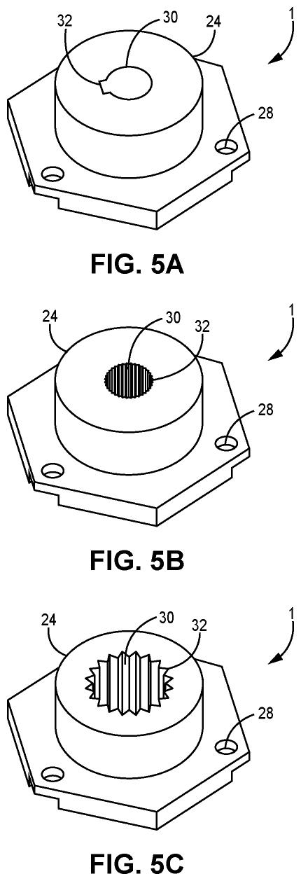

FIGS. 5A-C depict several implementations of a steering wheel spline/keyed insert 24 having a central lumen 30 and one or more features 32 for rotationally fixing the spline/keyed insert 24 to the appropriate steering column drive, as would be understood. For example, FIG. 5A includes a single notch feature 32 or keyed shaft feature 32. FIG. 5B shows features 32 being a plurality of shallow flutes. FIG. 5C shows a further design where the features 32 includes a plurality of pointed recesses and protrusions, forming a generally multi-pointed star shape. Various alternate designs are of course possible and would be understood by those of skill in the art.

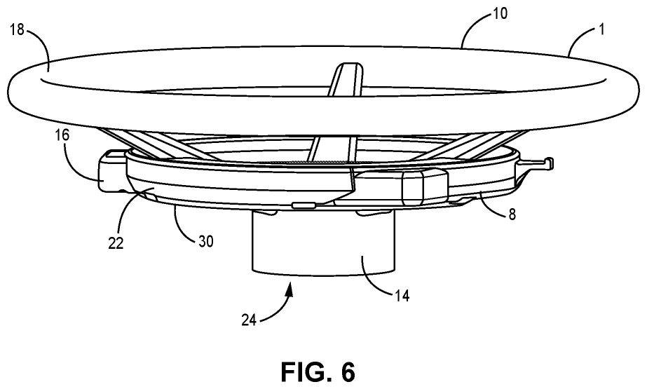

FIG. 6 depicts an assembled assisted steering assembly 1, according to certain implementations. As can be seen, the ring assembly 8 includes the ring gear 22 is located beneath the inner ring 16 and optional includes a cover 30. As would be understood, the cover 30 provides protection for the ring gear 22 and operators such that the teeth of the ring gear 22 are not exposed. In further implementations, the cover 30 improves the aesthetic/cosmetic function of the assembly 8, in that it creates a smooth/flush assembly 8.

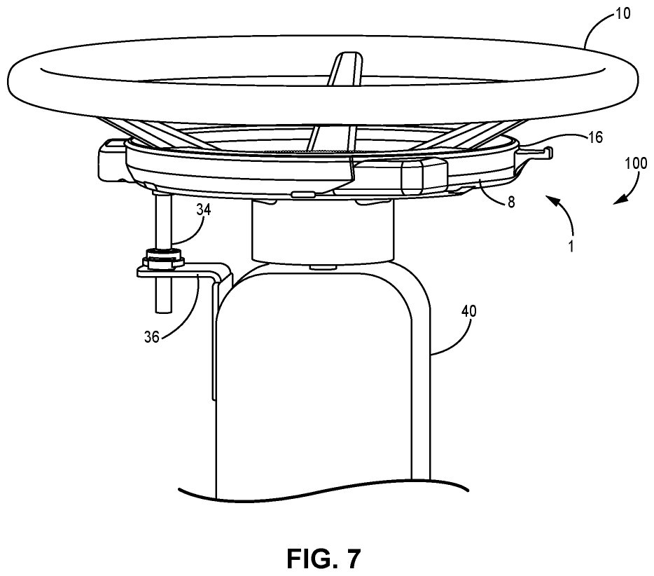

FIG. 7 depicts the assisted steering system 100 and assembly 1 showing the ring assembly 8 integrated with the steering wheel 10 and also including an anti-rotation pin 34 and anti-rotation bracket 36 installed on the steering column 40, according to certain implementations. It is understood that in use, according to certain implementations, the components pictured in FIG. 7 (including the steering wheel 10, ring assembly 8, anti-rotation pin 34, and anti-rotation bracket 36) stay on the vehicle and allow the vehicle to be manually steered even when the drive unit is absent.

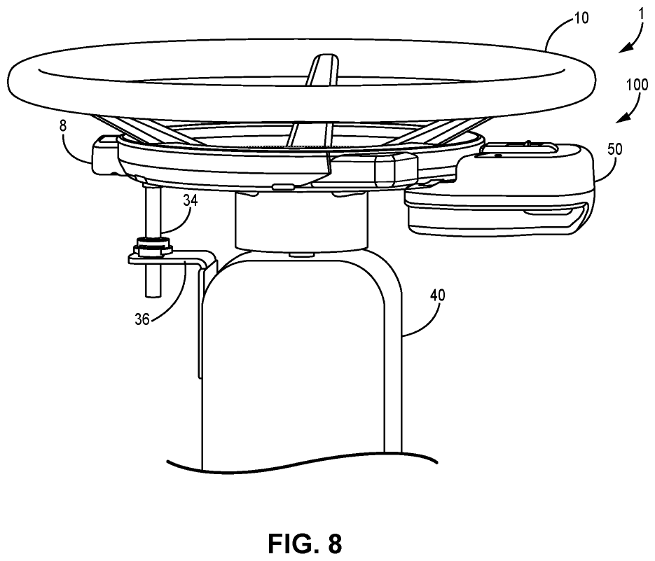

FIG. 8 depicts the assisted steering system 100 as shown in level diagram showing the steering wheel 10, ring assembly 8, anti-rotation pin 34 and anti-rotation bracket 36 installed on a steering column 40 having a drive unit 50 installed. The drive unit 50 may also be referred to as an MDU 50. The operation of the MDU 50 is known in the art and described further in certain of the incorporated references.

Combining the ring assembly 8 and ring gear 22 into the steering wheel 10 improves performance and customer perception of the ring assembly 8 by eliminating gaps in the ring assembly 8/gear 22 and provide an all in one installation of the ring assembly 8 while maintaining the ease of moving the MDU 50 to a different vehicle. The system 100, assisted steering assembly 1, and installation described herein may eliminate the need for a top ring (used in the prior application to hold the ring gear to the spokes of the steering wheel) as well as expand the installation capabilities to machines with unique steering wheels that are currently difficult to support with after-market/retrofitted assisted steering systems.

Although the disclosure has been described with references to various embodiments, persons skilled in the art will recognize that changes may be made in form and detail without departing from the spirit and scope of this disclosure.

What is claimed is:

1. An assisted steering assembly comprising:
(a) a steering wheel; and
(b) a ring assembly permanently integrated with the steering wheel, the ring assembly comprising:
(i) an inner ring;
(ii) a ring gear disposed on one side of the inner ring; and
(iii) a gear cover disposed at least partially about the ring gear.

2. The assisted steering assembly of claim 1, wherein the ring gear is affixed to the inner ring via one or more fasteners.

3. The assisted steering assembly of claim 1, further comprising a drive unit configured for releasable attachment to the ring assembly.

4. The assisted steering assembly of claim 1, wherein the steering wheel further comprises an outer ring configured for operator grip.

5. The assisted steering assembly of claim 1, further comprising an insert installed in a central hub of the steering wheel, the insert configured to interface with a steering column of a vehicle.

6. The assisted steering assembly of claim 5, wherein the insert comprises one or more of a notch, a plurality of splines, and one or more shaped protrusions.

7. The assisted steering assembly of claim 1, wherein the inner ring and ring gear are integral.

8. The assisted steering assembly of claim 1, further comprising an anti-rotation pin extending from the ring assembly and an anti-rotation bracket disposed on a steering column configured to prevent rotation of the steering wheel during use of an assisted steering system.

9. The assisted steering assembly of claim 1, wherein the ring assembly is formed with the steering wheel.

10. An assisted steering system comprising:
(a) a first steering wheel having a first integral ring assembly configured for installation in a first vehicle;
(b) a second steering wheel having a second integral ring assembly configured for installation in a second vehicle; and
(c) a drive unit configured for releasable attachment to the first integral ring assembly and the second integral ring assembly.

11. The assisted steering system of claim 10, wherein each of the first integral ring assembly and the second integral ring assembly comprise:
(a) an inner ring; and
(b) a ring gear disposed on one side of the inner ring.

12. The assisted steering system of claim 11, wherein each of the first integral ring assembly and the second integral ring assembly comprise a gear cover disposed at least partially about the ring gear.

13. The assisted steering system of claim 11, wherein the inner ring and ring gear are integral.

14. The assisted steering system of claim 10, wherein the first steering wheel further comprises an insert installed within a central hub of the first steering wheel configured to interface with a steering column of the first vehicle.

15. The assisted steering system of claim 14, wherein the insert comprises one or more of a notch, a plurality of splines, and one or more shaped protrusions.

16. The assisted steering system of claim 10, wherein each of the first steering wheel and second steering wheel further comprise:
(a) an anti-rotation pin extending from the respective ring assembly and
(b) an anti-rotation bracket disposed on a steering column configured to prevent rotation of the respective steering wheel during use.

17. The assisted steering system of claim 10, wherein the first vehicle remains operational when the drive unit is attached to the second integral ring assembly.

18. The assisted steering system of claim 10, wherein the first integral ring assembly is formed with the first steering wheel and wherein the second integral ring assembly is formed with the second steering wheel.

19. An assisted steering assembly comprising:
(a) a steering wheel;
(b) a ring assembly permanently integrated with the steering wheel, the ring assembly comprising:
(i) an inner ring;
(ii) a ring gear disposed on one side of the inner ring; and
(iii) a gear cover disposed at least partially about the ring gear;
(c) an anti-rotation pin extending from the ring assembly;
(d) an anti-rotation bracket disposed on a steering column configured to prevent rotation of the steering wheel; and
(e) a drive unit configured for releasable attachment to the ring assembly.

20. The assisted steering assembly of claim 19, further comprising an insert installed in a central hub of the steering wheel, the insert configured to interface with the steering column.
